(19) United States
(12) Patent Application Publication
(10) Pub. No.: US 2026/0320602 A1
(43) Pub. Date: Oct. 15, 2026

(54) SMART CONTRACT NETWORK FOR NON-CUSTODIAL ASSET RECOVERY IN CRYPTOCURRENCY NETWORKS

(71) Applicant: Circle Internet Group, Inc., New York, NY (US)

(72) Inventors: Alex Kroeger, New York, NY (US); Kaili Wang, New York, NY (US)

(21) Appl. No.: 19/648,756

(22) Filed: Apr. 15, 2026

Related U.S. Application Data
(60) Provisional application No. 63/789,191, filed on Apr. 15, 2025.

(51) Int. Cl. G06Q 20/40; G06Q 20/12; G06Q 20/38; H04L 9/32; H04L 9/40

(52) U.S. Cl. CPC G06Q 20/401; G06Q 20/123; G06Q 20/3823; G06Q 20/389; H04L 9/3213; H04L 9/3236; H04L 9/3247; H04L 9/40; G06Q 2220/00; H04L 2209/56

(57) ABSTRACT

Implementations of the present disclosure are directed to receiving a number of tokens of a digital asset at a smart contract executed within a cryptocurrency network in response to execution of a pay function of the smart contract by a sender, and holding, by the smart contract, at least a portion of the number of tokens until one of: transmitting the at least a portion of the number of tokens to a recipient in response to expiration of a release period, and transmitting the at least a portion of the number of tokens to the sender in response to execution of a return function of the smart contract.

### CROSS-REFERENCE TO RELATED APPLICATIONS

This application claims priority to and the benefit of U.S. Prov. App. No. 63/789,191, filed on Apr. 15, 2025, which is expressly incorporated herein by reference for all purposes.

### TECHNICAL FIELD

This specification relates generally to digital assets and more particularly to a smart contract network to facilitate non-custodial transactions in cryptocurrency networks.

### BACKGROUND

The development of distributed ledger technology has enabled a multitude of digital transactions not available in the pre-digital, pre-Internet world. For example, distributed ledger technology enables users to hold digital assets as stores of value and mediums of exchange with immutability and traceability. In general, a digital asset can be described as a virtual store of value that leverages a distributed ledger to store, record, and validate transactions. An example digital asset includes cryptocurrencies. Distributed ledgers can be referred to as blockchains or chains.

### SUMMARY

This specification describes systems, methods, devices, and other techniques relating to transactions of digital assets in cryptocurrency networks. More particularly, implementations of the present disclosure are directed to a smart contract network that facilitates non-custodial transactions in cryptocurrency networks.

In general, innovative aspects of the subject matter described in this specification can include actions of receiving a number of tokens of a digital asset at a smart contract executed within a cryptocurrency network in response to execution of a pay function of the smart contract by a sender, and holding, by the smart contract, at least a portion of the number of tokens until one of: transmitting the at least a portion of the number of tokens to a recipient in response to expiration of a release period, and transmitting the at least a portion of the number of tokens to the sender in response to execution of a return function of the smart contract. Other implementations of this aspect include corresponding systems, apparatus, and computer programs, configured to perform the actions of the methods, encoded on computer storage devices.

These and other implementations can each optionally include one or more of the following features: execution of the return function is called by a third-party; execution of the return function is called by the receiver; an address of the smart contract within the cryptocurrency network is provided as a parameter to the pay function; the sender receives the address of the smart contract from the recipient; actions further include receiving, by the smart contract, an early withdrawal request including an expected hash and a signature of the recipient, and selectively executing the early withdrawal request based on the expected hash and the signature; selectively executing the early withdrawal request based on the expected hash and the signature includes one of executing the early withdrawal request in response to determining that the signature is valid and that the expected hash is equal to an actual hash; and, in response to execution of the pay function, the smart contract generates a payment record for the number of tokens within a data structure.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example architecture in accordance with implementations of the present disclosure.

FIG. 2 depicts a conceptual architecture in accordance with implementations of the present disclosure.

FIG. 3 is a flowchart of an example process that can be executed in accordance with implementations of the present disclosure.

Like reference numbers and designations in the various drawings indicate like elements.

### DETAILED DESCRIPTION

The technology of this patent application is directed to transactions of digital assets in cryptocurrency networks. More particularly, implementations of the present disclosure are directed to a smart contract network that facilitates non-custodial transactions in cryptocurrency networks.

In some implementations, actions include receiving a number of tokens of a digital asset at a smart contract executed within a cryptocurrency network in response to execution of a pay function of the smart contract by a sender, and holding, by the smart contract, at least a portion of the number of tokens until one of: transmitting the at least a portion of the number of tokens to a recipient in response to expiration of a release period, and transmitting the at least a portion of the number of tokens to the sender in response to execution of a return function of the smart contract.

To provide context for the subject matter of the present disclosure, and as introduced above, users can hold digital assets as stores of value and mediums of exchange. In general, a digital asset can be described as a virtual store of value that leverages a peer-to-peer network to store, record, and validate transactions. The peer-to-peer network can maintain a distributed ledger (e.g., blockchain), which can be described as a decentralized database that immutably stores transactions across the peer-to-peer network. Example digital assets can include, without limitation, cryptocurrencies (e.g., stablecoins), non-fungible tokens (NFTs), security tokens, tokenized money market funds (T-MMF), and the like (e.g., tokenized government obligations).

In some examples, a cryptocurrency can be described as a digital currency that uses cryptography to secure transactions that are recorded in a distributed ledger (e.g., blockchain). In some examples, a stablecoin can be described as a cryptocurrency having a value that is tied (pegged) to the value of a real-world, non-digital asset, such as a fiat currency, a commodity, or a financial instrument. Stablecoins are absent the volatility of other cryptocurrencies and, as such, are a useful medium of exchange. An example stablecoin includes, without limitation, USDC™.

Implementations of the present disclosure are described in further detail herein with reference to example peer-to-peer networks (also referred to herein as chain networks), each maintaining a respective chain. Some example peer-to-peer networks can each be described as an Ethereum-compatible network. Ethereum can be described as a decentralized computing infrastructure that executes a virtual machine, referred to as the Ethereum virtual machine (EVM), to execute transactions on a chain. The EVM can be described as a global singleton and operates as a single-instance computer, globally across nodes of the peer-to-peer network. That is, each node in the network executes a local copy of the EVM to execute transactions on the chain. The chain of the peer-to-peer network records the changing state of the EVM as transactions are processed. While Ethereum is referenced herein for purposes of illustration, it is contemplated that implementations of the present disclosure can be realized using any appropriate peer-to-peer network (e.g., networks that provide on-chain computing; EVM-compatible chains). Example peer-to-peer networks can include, without limitation, Arbitrum, Avalanche, and Base, among several others, each of which is EVM-compatible. It is contemplated, however, that implementations of the present disclosure can be realized on non-EVM peer-to-peer networks, such as Solana, Aptos, Sui, and the like.

Digital assets can be used to as payments for products and/or services. In some examples, digital payment technologies enable merchants to accept payments from users in digital assets. To facilitate payments using digital assets of cryptocurrency networks, payments are held on-chain. In general, on-chain refers to transactions that occur on a blockchain and have been verified and authenticated, such that the data stored on the blockchain is immutable and permanent within the cryptocurrency network. However, in order for payments to be held on-chain on an institutional and large scale, refunds and chargebacks must be supported. It might be assumed that, if the cryptocurrency network is permissioned (i.e., closed and not publicly accessible; can have an access control layer, such that only permissioned users are allowed to access), then it can be relied that the recipient (e.g., merchant) can simply send back the funds. However, such an assumption would be naive given the complexities and, for example, regulatory framework around payments.

By way of non-limiting example, a user can purchase a “new” product online, but receive a product that has clearly been used. In traditional payment systems, such as credit cards, the issuer of the credit card can provide a process for dispute resolution to enable the user to dispute the charge. Such a trusted dispute resolution process enables buyers (payers) and sellers (recipients) to confidently engage in commerce. However, in using digital assets, such as cryptocurrencies (e.g., stablecoins), to transact in commerce, effective refund or chargeback mechanisms are absent. As such, transactions that use digital assets are more akin to cash transactions, where the payment involves only the movement of value from one party to another (from payer to recipient).

Without an on-chain arbiter protocol, a customer (payer) can buy from a merchant (recipient), for example, and the merchant can immediately receive the funds and use the funds however they wish. If they wish to refund the customer, but the merchant has already off-ramped (i.e., converted the digital assets to fiat currency), the merchant either needs to do the refund over fiat rails (expensive and slow), or needs to on-ramp again (i.e., convert fiat currency to digital assets), which introduces additional complexities and consumption of technical resources (e.g., computing that is executed to on-ramp fiat to digital currency). If the recipient had not yet off-ramped, there needs to be some additional infrastructure within the cryptocurrency network to return funds to the payer's original off-chain payment method. In chargebacks especially (but also refunds), there are scenarios where the return of funds to the payer must still take place, but it cannot be assumed that the recipient will initiate and source those funds.

One approach to addressing this issue is to delegate task dispute resolution to an all-powerful arbiter that would, for example, escrow funds for a period of time before sending payment to the recipient (or returning to the purchaser). In the context of cryptocurrency networks, this escrow account could be a single address controlled by the arbiter, who performs accounting and dispute resolution off-chain. While this solution is tempting in its simplicity, it introduces an entity that must be trusted by all parties. In short, such an architecture is not trust-minimized. Another problem with an all-powerful arbiter is that they have the ability to take (or lose) the digital assets held in the escrow account. As such, the all-powerful arbiter is custodial, meaning that they have full control and possession of the digital assets until they choose to forward the digital assets to the recipient (or return to the payer).

In view of the foregoing, implementations of the present disclosure are directed to a smart contract network that facilitates non-custodial dispute resolution in cryptocurrency networks. More particularly, implementations of the present disclosure provide a smart contract for on-chain dispute resolution, the smart contract being referred to herein as an arbiter contract. The arbiter contract can be described as a smart contract that introduces on-chain dispute resolution and escrow for ERC-20 payments. At a high level, smart contracts can be described as programs that are executed on-chain and are each provided as a collection of code (functions) and data (state) that resides at a specific address on the chain. Here, the arbiter contract is located at a specific address within the cryptocurrency network.

As described in further detail herein, the arbiter contract enables non-custodial returns, lockups, and mediated resolutions in cryptocurrency networks, while obviating the need for a trusted third-party as arbiter. That is, payers and recipients need not trust the arbiter that provisions the arbiter contract. In this manner, the arbiter contract enables payments using digital assets (e.g., stablecoins) to be safer and more flexible for real-world use. More plainly stated, the arbiter contract of the present disclosure is a smart contract that enables a third-party, an arbiter, to mediate payment disputes without taking direct custody of funds. That is, the third-party, as an arbiter, is non-custodial and trust-minimized.

In some implementations, the arbiter contract enables an arbiter to specify a lockup period during which a recipient's funds are held, to permit refunds to an address pre-specified by the payer, and to allow an early withdrawal of recipient funds (e.g., for a mutually agreed upon fee paid by the recipient to the arbiter). However, the arbiter specifically does not have the ability to send funds to an address of their choosing. In this manner, implementations of the present disclosure provide a smart contract network that is trust-minimized and non-custodial.

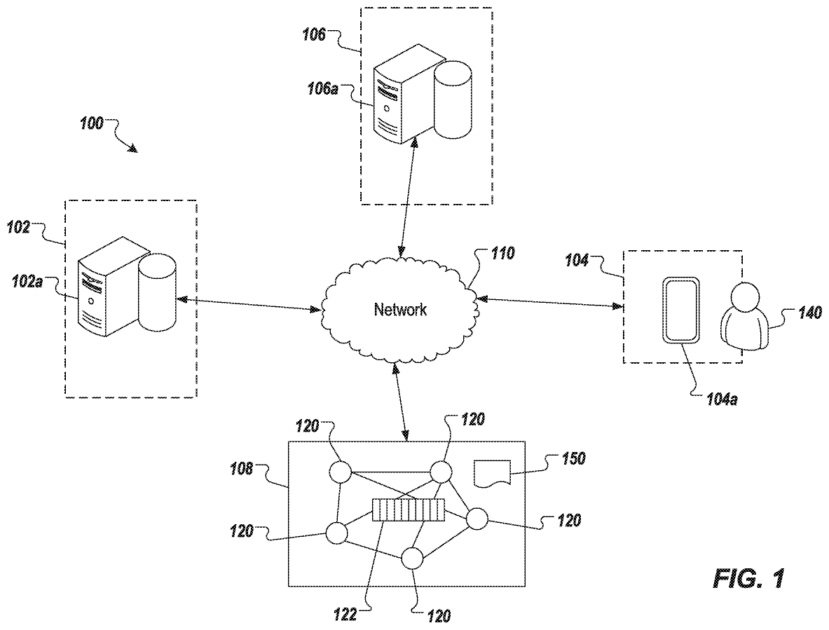

FIG. 1 depicts an example environment 100 that can be used to execute implementations of the present disclosure. In some examples, the example environment 100 enables entities to participate in a cryptographic network for secure communications. The example environment 100 includes an arbiter system 102, a payer system 104, a recipient system 106, a cryptographic network 108, and a network 110. In some examples, the network 110 includes a local area network (LAN), wide area network (WAN), the Internet, or a combination thereof, and connects web sites, user devices (e.g., computing devices), and back-end systems. In some examples, the network 110 can be accessed over a wired and/or a wireless communications link.

In the example use case, the cryptographic network 108 can be provided as a cryptocurrency network that enables a provider of a cryptocurrency (referred to herein as a minting entity) to distribute tokens of a cryptocurrency to users and that enables users to execute transactions related to the cryptocurrency. The cryptographic network 108 can be described as a peer-to-peer network of nodes 120 and transactions related to the cryptocurrency are immutably stored within a blockchain 122. For example, the blockchain 122 is a distributed ledger that is updated and stored across multiple nodes within the cryptographic network 108. Although the cryptographic network 108 is depicted separately from the network 110, it is contemplated that at least a portion of the cryptographic network 108 can be provided within the network 110 (e.g., as nodes that are distributed across the Internet).

In the depicted example, the arbiter system 102 includes a computing device 102a, which can, for example, represent one or more servers. In some examples, the arbiter system 102 can be operated by or on behalf of a third-party that acts as an arbiter in accordance with implementations of the present disclosure. In some examples, the third-party is a provider entity that generates and distributes a cryptocurrency. In this example, the computing device 102a is operated by the provider entity to mint tokens of the cryptocurrency and distribute tokens to users, as well as execute transactions. In some examples, the third-party can be any appropriate entity (e.g., the provider entity, an artificial intelligence (AI) agent, a multi-party computation (MPC) group (i.e., multiple parties functioning as the arbiter through cryptographic transactions)) that can function as a trustless, non-custodial arbiter, as described in further detail herein. Transactions associated with the cryptocurrency are recorded in the blockchain 122 of the cryptographic network 108. In some examples, the computing device 102a can function as a node of the cryptographic network 108.

In the depicted example, the payer system 104 includes a computing device 104a. In some examples, the computing device 104a can include, without limitation, a server, a desktop computer, a laptop computer, a tablet computing device, and a smartphone. In some implementations, a user 140 uses the device 104a to execute transactions within the network 110 and/or the cryptographic network 108. In some examples, transactions executed in the cryptographic network 108 are immutably recorded in the blockchain 122 of the cryptographic network 108. Example transactions can include, without limitation, purchasing tokens of a cryptocurrency from the provider entity, transferring tokens of cryptocurrency to recipients, and transferring tokens of cryptocurrency to arbiter(s).

In the depicted example, the recipient system 106 includes a computing device 106a. In some examples, the computing device 106a can include, without limitation, a server, a desktop computer, a laptop computer, a tablet computing device, and a smartphone. In some implementations, a commercial entity uses the device 106a to execute transactions within the network 110 and/or the cryptographic network 108. In some examples, transactions executed in the cryptographic network 108 are immutably recorded in the blockchain 122 of the cryptographic network 108. Example transactions can include, without limitation, receiving tokens of a cryptocurrency.

In accordance with implementations of the present disclosure, a smart contract network is provisioned within the cryptocurrency network 108 that enables arbitration between the user 140 and the commercial entity. In some examples, the smart contract network includes an arbiter contract 150. The arbiter contract 150 is associated with an arbiter address that is a unique address withing the cryptocurrency network 108. In some examples, the arbiter contract 150 is deployed to the cryptocurrency network 108 by an arbiter, such as the third-party of the arbiter system 102.

In some examples, the user 140 can interact with an entity over the network 110, which interactions can result in the user 140 transferring tokens of cryptocurrency to the entity. For example, the user 140 can purchase goods and/or services from the entity. In consideration for the goods and/or services, the user 140 transfers tokens of the cryptocurrency intended for the entity. As described in further detail herein, the tokens are transferred to the arbiter contract 150 for an intermediate period of time. In some examples, the tokens are ultimately transferred to the entity or are returned to the user 140 by the arbiter contract 150.

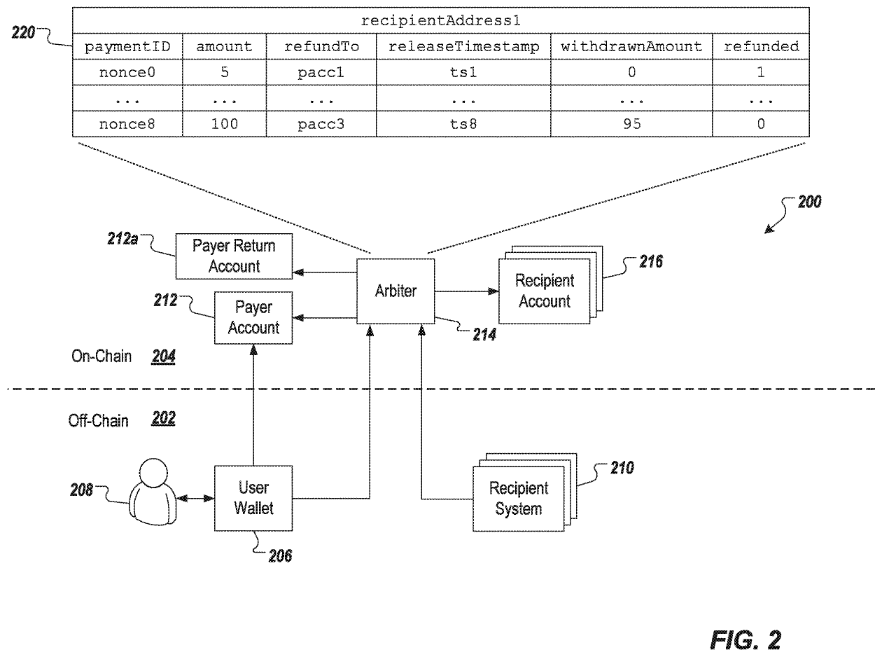

FIG. 2 depicts a conceptual architecture 200 in accordance with implementations of the present disclosure. The example of FIG. 2 depicts an off-chain side 202, an on-chain side 204, a user wallet 206, a user 208, recipient systems 210, a payer account 212, a payer return account 212a, an arbiter contact 214, and recipient accounts 216. In this example, the user 208 can interact with multiple recipients (e.g., merchants), each recipient having a respective recipient system 210. For example, and as described in further detail herein, the user 208, as a customer can interact with a recipient system 210 (e.g., an e-commerce site) to select and pay, as a payer, for goods/services provisioned by the respective recipient.

Here, the user wallet 206 can include an off-chain application or that stores and manages a private keys (cryptographic keys) of the user 208 (i.e., the user wallet 206 does not hold tokens). The tokens that the user 208 owns remain recorded on the blockchain, while the user wallet 206 enables the user 208 to control addresses within the blockchain that tokens can be transferred to. To transfer tokens, the user wallet 206 constructs transaction data and uses the private key of the user 208 to generate a digital signature, which proves authorization without revealing the private key itself. The signed transaction is broadcast to the cryptocurrency network, where nodes validate the signature and, if valid, update the ledger to reflect the transfer.

In the context of the present disclosure, each recipient can indicate that payments (transfer of tokens of cryptocurrency) are to be made to the arbiter contract 214 and a specific recipient account 216 that payments are (ultimately, assuming no return) to be made to. For example, to conclude an online transaction (e.g., a purchase of goods/services), the recipient system 210 provides the address of the arbiter contract 214 and the address of the recipient account 216, and the user 208 uses the user wallet 206 to transfer tokens to the arbiter contract 214, which performs multiple functionality, as described in detail herein.

In some implementations, the arbiter contract 214 is provided with one or more recipient accounts 216 that can receive tokens from the arbiter contract 214. In some examples, the arbiter contract 214 can keep track of transactions based on a unique recipient identifier (recipientID) and/or unique recipient account addresses (recipientAddress).

In further detail, the arbiter contract 214 can be described as an immutable database that tracks payments received and payments eventually to be claimed by recipients from payers, such as the user 208. Example code for the arbiter contract 214 can be provided as:

Listing 1: Example Code of Arbiter Contract

```
contract Arbiter is EIP712 {
  struct Payment {
    address to;
    uint256 amount;
    uint256 releaseTimestamp;
    address refundTo;
    uint256 withdrawnAmount;
    bool refunded;
  }
  uint256 public constant MAX_LOCKUP_SECONDS = 60 * 60 *
24 * 180; // 180 days
  bytes32 public constant EARLY_WITHDRAWAL_TYPEHASH =
keccak256(
    “EarlyWithdrawalByArbiter(uint256[ ]
paymentIDs,uint256[ ] withdrawalAmounts,uint256
feeAmount,uint256 expiry,uint256 salt)”
  );
  IERC20 public fiatToken;
  uint256 public nonce;
  address public arbiter;
  mapping(address => uint256) public lockupSeconds;
  mapping(uint256 => Payment) public payments;
  mapping(address => uint256) public balances;
  mapping(address => uint256) public debts;
  mapping(bytes32 => bool) public withdrawalHashes;
  event PaymentCreated(
    uint256 indexed paymentID,
    address indexed to,
    uint256 amount,
    uint256 releaseTimestamp,
    address indexed refundTo
  );
  event Refund(uint256 indexed paymentID, address indexed
refundTo, uint256 amount);
  event RefundToUpdated(uint256 indexed paymentID,
address indexed oldRefundTo, address indexed newRefundTo);
  event Withdrawal(address indexed to, uint256 amount);
  event WithdrawalFeePaid(address indexed recipient,
uint256 amount);
  error CallerNotAllowed( );
  error PaymentIsStillLocked(uint256 paymentID);
  error PaymentDoesNotBelongToRecipient( );
  error RefundToIsZeroAddress( );
  error InsufficientFunds( );
  error InvalidWithdrawalAmount(uint256 paymentID,
uint256 withdrawalAmount);
  error InvalidFeeAmount( );
  error InvalidSignature( );
  error WithdrawalHashAlreadyUsed( );
  error WithdrawalHashExpired( );
  error PaymentRefunded(uint256 paymentID);
  error LockupSecondsExceedsMax( );
  error MismatchedEarlyWithdrawalArrays( );
  constructor(address _arbiter, address _usdc, string
memory eip712Name, string memory eip712version)
    EIP712(eip712Name, eip712version)
  {
    arbiter = _arbiter;
    fiatToken = IERC20(_usdc);
    nonce = 0;
  }
  modifier onlyArbiter( ) {
    if (msg.sender != arbiter) {
      revert CallerNotAllowed( );
    }
    _;
  }
```

In the example of Listing 1, example cryptocurrency is provided as USDC™, a stablecoin.

To illustrate how the arbiter contract 214 functions, a non-limiting example of a lifecycle of a token transaction can be considered. In some examples, payers (e.g., the user 208) send tokens of a digital asset (e.g., ERC20 tokens) by calling a pay function of the arbiter contract 214. An example pay function can be provided as:

Listing 2: Example Pay Function

```
function pay(address to, uint256 amount, address refundTo)
external {
    if (refundTo == address(0)) {
      revert RefundToIsZeroAddress( );
    }
    uint256 recipientlockupSeconds = lockupSeconds[to];
    fiatToken.transferFrom(msg.sender, address(this),
amount);
    payments[nonce] = Payment(to, amount,
block.timestamp + recipientlockupSeconds, refundTo, 0,
false);
    balances[to] += amount;
    emit PaymentCreated(nonce, to, amount,
block.timestamp + recipientlockupSeconds, refundTo);
    nonce += 1;
  }
```

In the example of Listing 2, a payment data structure (Payment) is generated. For example:

Listing 3: Example Payment Data Structure

```
struct Payment {
    address to;
    uint256 amount;
    uint256 releaseTimestamp;
    address refundTo;
    uint256 withdrawnAmount;
    bool refunded;
  }
```

In the example of Listing 3, execution of the pay function (Listing 2) results in a payment data structure that includes a recipient address (to) (e.g., the address of the recipient account 216 within the cryptographic network), a payment amount (amount) (e.g., a number of tokens to be transferred to the recipient account), a release timestamp (releaseTimestamp) defining a duration that the payment amount is held by the arbiter contract 214, a refund address (refundTo) (e.g., an address defined by the payer, to which the amount is returned in the event of a refund), a withdrawn amount (withdrawnAmount), and a refunded status (refunded) (e.g., boolean value indicating whether refund has been performed).

In some examples, in calling the pay function, a payer provides the recipient address (to), the payment amount (amount), and the refund address (refundTo). In some examples, the refund address can be the payer account 212, from which tokens of the user 208 are transferred to the arbiter contract 214. In some examples, the refund address can be the payer return account 212a.

It can be noted that specifying a refund address (within a cryptocurrency network) at the time of payment might not be trivial. For instance, a payer making a payment might be using a custodial wallet. In that case, the custodial wallet would need to support an interface with the arbiter contract 214 to specify an address that would be earmarked for refunds to the payer. More difficult still, the payer might not be the one holding tokens of the digital asset. Instead, the payer could ultimately be paying in fiat currency and using an onramp provider that provides tokens of the digital asset. It would then be incumbent on the onramp provider to specify an address to which refunds can be routed.

After the pay function is executed, the payment is considered as having been rendered, though the funds are transferred to the arbiter contract 214 instead of being sent to the recipient account 216 (i.e., the recipient address (to)). In some examples, each payment that is held in the arbiter contract 214 is uniquely identified by a respective payment identifier (paymentID). The payment identifier is unique for each payment and remains static for a payment throughout the lifecycle of the payment (e.g. even if the liability of the refund changes to a different address). In some examples, the payment identifier is provided as a nonce value that is incremented each time a new payment is received.

In the example of FIG. 2, a table 220 is depicted that represents payment data structures for tracking payments and returns in accordance with implementations of the present disclosure. The table 220 represents payments made for a recipient address (recipientAddress1) (i.e., execution of the pay function where to is recipientAddress1). In the example of FIG. 2, a payment (nonce0) has been refunded to a payment account (pacc1) (e.g., as indicated by refunded being set to 1). Also in the example of FIG. 2, a payment (nonce8) has not been refunded to a payment account (pacc3) (e.g., as indicated by refunded being set to 0).

In some examples, and assuming that no refund is executed, a payment amount is held by the arbiter contract 214 until the respective release timestamp is reached. In response to reaching the release timestamp, the payment amount can be transferred from the arbiter contract 214 to the respective recipient account 210 (i.e., the recipient address (to)). For example, the withdraw function can be called to transfer the payment amount. In some examples, the release timestamp is determined at the time that the pay function is called. For example, a payment timestamp (paymentTimestamp) represents a time when the pay function was called and the release timestamp (releaseTimestamp) is determined by adding a lockup period (recipientLockupSeconds) (e.g., 60*60*24*30; 30 days) to the payment timestamp (paymentTimestamp).

In some examples, the lockup period (recipientLockupSeconds) can be defined by calling a lockup period function (setLockupSeconds). For example:

Listing 4: Example Lockup Period Function

```
function setLockupSeconds(address recipient, uint256
recipientLockupSeconds) external onlyArbiter {
    if (recipientLockupSeconds > MAX_LOCKUP_SECONDS) {
      revert LockupSecondsExceedsMax( );
    }
    lockupSeconds[recipient] = recipientLockupSeconds;
  }
```

In the example of Listing 4, if a lockup time exceeds a maximum lockup time (MAX_LOCKUP_SECONDS) (e.g., 60*60*24*180; 180 days), an error is returned. The lockup period function (setLockupSeconds) can again be called.

In some implementations, if there is an issue between the payer and the recipient (e.g., lack of delivery, quality, wrong item delivered), the payer can dispute the payment to initiate a refund. In some examples, a refund can be executed by the recipient by calling a refund-by-recipient function (refundByRecipient). In some examples, a refund can be executed by the arbiter by calling a refund-by-arbiter function (refundByArbiter).

For example, the payer can contact the recipient directly, and the recipient can issue a refund with the arbiter contract 214 using the refund-by-recipient function (refundByRecipient), which can be provided as:

Listing 5: Example Refund-By-Recipient Function

```
function refundByRecipient(uint256 paymentID) external {
  Payment memory payment = payments[paymentID];
  if (msg.sender != payment.to) {
    revert CallerNotAllowed( );
  }
  uint256 recipientBalance = balances[payment.to];
  if (payment.amount > recipientBalance) {
    revert InsufficientFunds( );
  }
  balances[payment.to] = recipientBalance −
payment.amount;
  _executeRefund(paymentID, payment);
}
```

In some examples, the payer can request that the arbiter initiates a refund (e.g., in the case where the recipient disputes the refund). In some examples, the arbiter can call the refund-by-arbiter function (refundByArbiter), which can be provided as:

Listing 6: Example Refund-By-Arbiter Function

```
function refundByArbiter(uint256 paymentID) onlyArbiter
external {
  Payment memory payment = payments[paymentID];
  uint256 recipientBalance = balances[payment.to];
  if (payment.amount <= recipientBalance) {
    balances[payment.to] = recipientBalance −
payment.amount;
    return _executeRefund(paymentID, payment);
  }
  uint256 arbiterBalance = balances[arbiter];
  if (payment.amount > arbiterBalance) {
    revert InsufficientFunds( );
  }
  balances[arbiter] = arbiterBalance − payment.amount;
  debts[payment.to] += payment.amount;
  _executeRefund(paymentID, payment);
}
```

In some implementations, in a refund-by-arbiter scenario, disputes can be mediated off-chain (e.g., the parties provide information and evidence to the arbiter by text, electronic mail, call, etc.). Because refund rates (e.g., how often the arbiter grants refund requests) are transparent, the arbiter has an incentive to apply reasonable standards when fulfilling refund requests.

Continuing, after the lockup period has passed, the recipient is able to withdraw the payment amount associated with one or more payments without any input from the arbiter (as long as that payment has not been refunded). In some examples, the arbiter contract 214 includes a permissionless withdraw function (withdraw) that allows recipients to withdraw their funds from the arbiter contract. In some examples, the withdraw function (withdraw) fails if the caller is not the recipient of the payment, the payment is still locked (i.e., the release timestamp has not been reached), or the payment has already been refunded. In some examples, the recipient can call the withdraw function (withdraw) for batches of payments. An example withdraw function (withdraw) can be provided as:

Listing 7: Example Withdraw Function

```
function withdraw(uint256[ ] calldata paymentIDs) external {
    _settleDebt(msg.sender);
    uint256 totalAmount = 0;
    for (uint256 i = 0; i < paymentIDs.length; ++i) {
      Payment memory payment =
payments[paymentIDs[i]];
      if (payment.to != msg.sender) {
        revert CallerNotAllowed( );
      }
      if (block.timestamp < payment.releaseTimestamp)
{
        revert PaymentIsStillLocked(paymentIDs[i]);
      }
      if (payment.refunded) {
        revert PaymentRefunded(paymentIDs[i]);
      }
      totalAmount += payment.amount −
payment.withdrawnAmount;
      payments[paymentIDs[i]].withdrawnAmount =
payment.amount;
    }
    uint256 recipientBalance = balances[msg.sender];
    if (totalAmount > recipientBalance) {
      revert InsufficientFunds( );
    }
    balances[msg.sender] = recipientBalance −
totalAmount;
    fiatToken.transfer(msg.sender, totalAmount);
    emit Withdrawal(msg.sender, totalAmount);
  }
```

The example of Listing 7 accounts for batch payments, where each payment in the batch is indicated by an index (i).

In some examples, and as discussed in further detail herein, funds can be withdrawn early (e.g., before reaching the release timestamp). In such cases, if the funds have already been withdrawn early, and the recipient has an insufficient balance from which to refund, the arbiter could choose to cover the amount of the refund themselves, and register a debt owed by the recipient to the arbiter in the arbiter contract 214 to be covered by future payments.

In further detail, the recipient may want access to the funds sooner than the lockup period allows. This can be made possible with an early withdraw function. The arbiter can choose, for example, that only X% (e.g., 5%) of received funds are to be held in the arbiter contract 214 as a buffer to satisfy future disputes. The arbiter can allow early withdrawals from the arbiter contract 214. In some examples, the arbiter can set a fee for allowing early withdrawals, the fee being defined in the withdraw function. In order to protect the recipient from arbitrary fees set by the arbiter, the early withdrawal involves an off-chain signature from the recipient to indicate their consent to the withdrawal terms. This signature is verified on-chain before the withdrawal is executed. For example, an early withdrawal by arbiter function can be provided as:

Listing 8: Example Early Withdrawal By
Arbiter Function of Arbiter Contract

```
function earlyWithdrawByArbiter(
    uint256[ ] calldata paymentIDs,
    uint256[ ] calldata withdrawalAmounts,
    uint256 feeAmount,
    uint256 expiry,
    uint256 salt,
    address recipient,
    uint8 v,
    bytes32 r,
    bytes32 s
  ) external onlyArbiter {
    bytes32 withdrawalInfoHash =
_hashEarlyWithdrawalInfo(paymentIDs, withdrawalAmounts,
feeAmount, expiry, salt);
    // prevent replay attacks
    if (withdrawalHashes[withdrawalInfoHash]) {
      revert WithdrawalHashAlreadyUsed( );
    }
    if (ecrecover(withdrawalInfoHash, v, r, s) !=
recipient) {
      revert InvalidSignature( );
    }
    if (block.timestamp > expiry) {
      revert WithdrawalHashExpired( );
    }
    uint256 totalAmount = 0;
    if (paymentIDs.length != withdrawalAmounts.length)
{
      revert MismatchedEarlyWithdrawalArrays( );
    }
    for (uint256 i = 0; i < paymentIDs.length; ++i) {
      uint256 paymentID = paymentIDs[i];
      uint256 withdrawalAmount =
withdrawalAmounts[i];
      Payment memory payment = payments[paymentID];
      if (withdrawalAmount > payment.amount) {
        revert InvalidWithdrawalAmount(paymentID,
withdrawalAmount);
      }
      if (payment.to != recipient) {
        revert PaymentDoesNotBelongToRecipient( );
      }
      if (payment.refunded) {
        revert PaymentRefunded(paymentID);
      }
      totalAmount += withdrawalAmount;
      payments[paymentID].withdrawnAmount +=
withdrawalAmount;
    }
    if (feeAmount > totalAmount) {
      revert InvalidFeeAmount( );
    }
    uint256 recipientBalance = balances[recipient];
    if (recipientBalance < totalAmount) {
      revert InsufficientFunds( );
    }
    balances[recipient] = recipientBalance −
totalAmount;
    balances[arbiter] += feeAmount;
    fiatToken.transfer(recipient, totalAmount −
feeAmount);
    emit Withdrawal(recipient, totalAmount);
    emit WithdrawalFeePaid(recipient, feeAmount);
    withdrawalHashes[withdrawalInfoHash] = true;
  }
```

In the example of Listing 8, the recipient must accept the terms of the early withdrawal by signing (using a private key of the recipient) a hash of the withdrawal information. Here, paymentIDs is an array of payment identifiers subject to the early withdraw, withdrawalAmounts is an array of withdrawal amounts, feeAmount is an overall fee amount to the arbiter for the early withdrawal, expiry is an expiration time for the early withdrawal, salt is a (random) value to make the hash unique, recipient is the address to which to send the tokens, and v, r, and s are each a value of the signature.

Another example function is an external function (external to the arbiter contract 214) to hash early withdraw information (e.g., the recipient executes the hash function to provide the hash for the early withdraw function). For example:

Listing 9: Example Hash Function

```
function hashEarlyWithdrawalInfo(
  uint256[ ] calldata paymentIDs,
  uint256[ ] calldata withdrawalAmounts,
  uint256 feeAmount,
  uint256 expiry,
  uint256 salt
) external view returns (bytes32) {
  return _hashEarlyWithdrawalInfo(paymentIDs,
withdrawalAmounts, feeAmount, expiry, salt);
}
```

In the example of Listing 9, paymentIDs is the array of payment identifiers to release, withdrawalAmounts is the array of amounts to withdraw from those payment identifiers, feeAmount is the fee amount for the early withdrawal, expiry is the expiration time for the early withdrawal, and salt is a value to make the hash unique.

Another example function is an internal function (internal to the arbiter contract 214) to hash early withdraw information (e.g., the arbiter contract 214 executes the hash function to provide the hash for the early withdraw function). For example:

Listing 10: Example Hash Function

```
function _hashEarlyWithdrawalInfo(
  uint256[ ] calldata paymentIDs,
  uint256[ ] calldata withdrawalAmounts,
  uint256 feeAmount,
  uint256 expiry,
  uint256 salt
) internal view returns (bytes32) {
  bytes32 structHash =
    keccak256(abi.encode(EARLY_WITHDRAWAL_TYPEHASH,
paymentIDs, withdrawalAmounts, feeAmount, expiry, salt));
  return _hashTypedDataV4(structHash);
}
```

In the example of Listing 10, paymentIDs is the array of payment identifiers to release, withdrawalAmounts is the array of amounts to withdraw from those payment identifiers, feeAmount is the fee amount for the early withdrawal, expiry is the expiration time for the early withdrawal, and salt is a value to make the hash unique.

Accordingly, in executing the early withdraw function, the recipient executes the external hash function to generate an expected withdraw hash and generates a signature for the expected hash using a private key, the expected hash and the signature being provided to the arbiter contract 214. The arbiter contract validates the signature using a public key of the recipient and executes the internal hash function to generated an actual withdraw hash. If the signature is valid and the actual withdraw hash is the same as the expected withdraw hash, the early withdraw is executed. Otherwise, an error is provided (e.g., to the recipient).

Another example function enables the payer (e.g., the user 208) to update a refund address (e.g., change refund address from the payer account 212 to the payer return account 212a). For example:

Listing 11: Example Update Refund Address Function

```
  function updateRefundTo(uint256 paymentID, address
newRefundTo) external {
    if (newRefundTo == address(0)) {
      revert RefundToIsZeroAddress( );
    }
    Payment memory payment = payments[paymentID];
    if (msg.sender != payment.refundTo) {
      revert CallerNotAllowed( );
    }
    emit RefundToUpdated(paymentID, payment.refundTo,
newRefundTo);
    payments[paymentID].refundTo = newRefundTo;
  }
```

Another example function is an internal function to execute a refund (e.g., upon reaching the release timestamp). For example:

Listing 12: Example Refund Function

```
function _executeRefund(uint256 paymentID, Payment memory
payment) internal {
  if (payment.refunded) {
      revert PaymentRefunded(paymentID);
  }
  fiatToken.transfer(payment.refundTo, payment.amount);
    payments[paymentID].refunded = true;
    emit Refund(paymentID, payment.refundTo,
payment.amount);
}
```

Here, paymentID is the payment identifier to refund and payment is the payment data structure.

Another example function can be executed by the arbiter contract 214 to settle any debt that the recipient might have to the arbiter. This can occur, for example, if the recipient performs early withdraws that exceed refunds to payers, which difference the arbiter has covered. For example:

Listing 13: Example Debt Settlement Function

```
function _settleDebt(address recipient) internal {
    uint256 recipientDebt = debts[recipient];
    uint256 recipientBalance = balances[recipient];
    uint256 settleAmount = recipientBalance < recipientDebt
? recipientBalance : recipientDebt;
    balances[recipient] = recipientBalance − settleAmount;
      balances[arbiter] += settleAmount;
  debts[recipient] = recipientDebt − settleAmount;
}
```

Here, recipient is the recipient address for debt settlement.

In some implementations, and as described in detail herein, the payment is deposited with the arbiter contract 214 and a separate transaction is executed to withdraw the payment (e.g., to transfer the payment to a recipient). To accommodate different withholding periods for each payment, withdrawals reference the state of each payment individually, as described herein. In some examples, for convenience, withdrawals can happen in a batch in a single transaction, with the expenditure of technical resources scaling linearly with the number of payments being withdrawn (e.g., it is roughly 10×more expensive (in terms of technical resources consumed) to withdraw a balance of 100 that is composed of 100 separate payments than a balance of 100 that is composed of 10 separate payments).

In some implementations, yield can be earned on escrowed digital assets. For example, digital assets sitting in the arbiter contract 214 being held to settle future disputes are unproductive. To address, in some implementations, the arbiter contract 214 can be extended to allow funds to be swept into a lending protocol that enables yield to be earned. In some examples, the yield could be shared with the payment recipients, and perhaps some could be kept by the arbiter as a further way to monetize their role as the third-party that handles disputes.

Implementations of the present disclosure can be configured to support contract wallets. In some examples, the arbiter contract 214 can assume that the recipient wallet is an EOA, since only EIP-712 signatures are supported for early withdrawals. If needed, the arbiter contract 214 can be extended to support EIP-1271 signatures to allow the recipient address to itself be a contract.

The protocol, as performed using the arbiter contract, of the present disclosure is scalable with the number of payments and users. An example of a non-scalable solution is a protocol that must create a new contract for each escrowed payment. The calls to pay in, pay out, and refund are efficient in terms of technical resources expended. Further, being on-chain, the arbiter contract cannot be hacked and funds cannot be misplaced due to fault of the arbiter contract. In accordance with implementations of the present disclosure, the arbiter's power can be limited to just dispute resolution-the arbiter should only have the power to forward the funds to the intended recipient or refund it back to the payer. The dispute resolution period can be fixed to avoid an indefinite lock-up of the funds. Because the arbiter cannot send the funds to an address of their choosing and cannot indefinitely prevent the recipient from retrieving their funds, the arbiter is non-custodial.

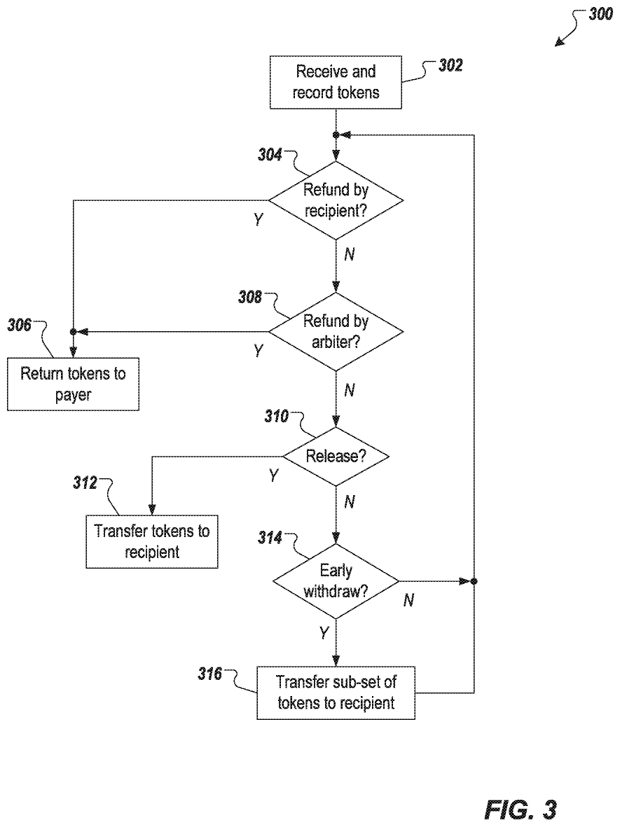

FIG. 3 is a flowchart of an example process 300 that can be executed in accordance with implementations of the present disclosure. In some examples, the example process 300 is provided using one or more computer-executable programs executed by one or more computing devices.

Tokens are received and recorded (302). For example, and as described in detail herein, a payer (e.g., the user 208 of FIG. 2) calls a pay function of an arbiter contract (e.g., the arbiter contract 214, which is indicated for payments by a recipient) to transfer tokens to the arbiter contract, which records the tokens in a payment record having a payment identifier assigned thereto. As described herein, in calling the pay function, the payer provides a recipient address (to), a payment amount (amount), and a refund address (refundTo). In some examples, the payment record is provided in a table for the respective recipient address (e.g., the table 220 of FIG. 2).

It is determined whether the recipient has instructed a refund (304). For example, and as described in detail herein, the recipient can call a refund-by-recipient function to return tokens to the payer. If the recipient has instructed a refund, the tokens are returned to the payer (306). For example, and as described in detail herein, the arbiter contract, in response to the call to the refund-by-recipient function, the tokens are transferred to the payer account (or payer return account).

If the recipient has not instructed a refund, it is determined whether the arbiter has instructed a refund (308). For example, and as described in detail herein, the payer can appeal to the arbiter for a return of the tokens, if, for example, the recipient has refused or otherwise disputed the return. If the arbiter determines that a return of the tokens is not appropriate, not action is taken to return the tokens. If the arbiter determines that a return of the tokens is appropriate, the arbiter calls a return-by-arbiter function and the arbiter contract, in response to the call to the refund-by-arbiter function, transfers the tokens to the payer account (or payer return account).

If the arbiter has not instructed a refund, it is determined whether the tokens are to be released to the recipient (310). For example, and as described in detail herein, it can be determined whether a release timestamp has been achieved and, if achieved, the tokens can be released to the recipient. That is, for example, the arbiter contract transfers the tokens to the recipient address (312). In some examples, the transfer is minus any early withdrawal that has already been performed.

If the tokens are not to be released to the recipient, it is determined whether early withdrawal has been requested (314). For example, and as described in detail herein, the recipient can call an early withdrawal function to release at least a sub-set of the tokens. In some examples, the early withdraw request is selectively approved by the arbiter contract. For example, the arbiter contract validates a signature of the recipient and a hash for the early withdrawal. In some examples, the arbiter contract validates an amount of early withdrawal requested (e.g., if the request exceeds an allowed amount individually, or collectively with previously executed early withdrawal(s)). If any validation fails, the request is declined. If all validations succeed, the request is approved. If an early withdrawal has not been requested or is not approved, the example process 300 loops back. If an early withdrawal has been requested and is approved, a sub-set of tokens is transferred to the recipient (316) and is recorded in the payment record, and the example process 300 loops back.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for facilitating transactions of digital assets using a smart contract network within cryptocurrency networks, comprising:
receiving a number of tokens of a digital asset at a smart contract executed within a cryptocurrency network in response to execution of a pay function of the smart contract by a sender; and
holding, by the smart contract, at least a portion of the number of tokens until one of:
transmitting the at least a portion of the number of tokens to a recipient in response to expiration of a release period, and
transmitting the at least a portion of the number of tokens to the sender in response to execution of a return function of the smart contract.

2. The computer-implemented method of claim 1, wherein execution of the return function is called by a third-party.

3. The computer-implemented method of claim 1, wherein execution of the return function is called by the receiver.

4. The computer-implemented method of claim 1, wherein an address of the smart contract within the cryptocurrency network is provided as a parameter to the pay function.

5. The computer-implemented method of claim 4, wherein the sender receives the address of the smart contract from the recipient.

6. The computer-implemented method of claim 1, further comprising:
receiving, by the smart contract, an early withdrawal request comprising an expected hash and a signature of the recipient; and
selectively executing the early withdrawal request based on the expected hash and the signature.

7. The computer-implemented method of claim 6, wherein selectively executing the early withdrawal request based on the expected hash and the signature comprises one of:
executing the early withdrawal request in response to determining that the signature is valid and that the expected hash is equal to an actual hash.

8. The computer-implemented method of claim 1, wherein, in response to execution of the pay function, the smart contract generates a payment record for the number of tokens within a data structure.

9. A non-transitory computer-readable storage medium coupled to one or more processors and having instructions stored thereon which, when executed by the one or more processors, cause the one or more processors to perform operations comprising:
receiving a number of tokens of a digital asset at a smart contract executed within a cryptocurrency network in response to execution of a pay function of the smart contract by a sender; and
holding, by the smart contract, at least a portion of the number of tokens until one of:
transmitting the at least a portion of the number of tokens to a recipient in response to expiration of a release period, and
transmitting the at least a portion of the number of tokens to the sender in response to execution of a return function of the smart contract.

10. The non-transitory computer-readable storage medium of claim 9, wherein execution of the return function is called by a third-party.

11. The non-transitory computer-readable storage medium of claim 9, wherein execution of the return function is called by the receiver.

12. The non-transitory computer-readable storage medium of claim 9, wherein an address of the smart contract within the cryptocurrency network is provided as a parameter to the pay function.

13. The non-transitory computer-readable storage medium of claim 12, wherein the sender receives the address of the smart contract from the recipient.

14. The non-transitory computer-readable storage medium of claim 9, wherein operations further comprise:
receiving, by the smart contract, an early withdrawal request comprising an expected hash and a signature of the recipient; and
selectively executing the early withdrawal request based on the expected hash and the signature.

15. The non-transitory computer-readable storage medium of claim 14, wherein selectively executing the early withdrawal request based on the expected hash and the signature comprises one of:
executing the early withdrawal request in response to determining that the signature is valid and that the expected hash is equal to an actual hash.

16. A system, comprising:
one or more processors; and
a non-transitory computer-readable storage device and having instructions stored thereon which, when executed by the computing device, cause the computing device to perform operations comprising:
receiving a number of tokens of a digital asset at a smart contract executed within a cryptocurrency network in response to execution of a pay function of the smart contract by a sender; and
holding, by the smart contract, at least a portion of the number of tokens until one of:
transmitting the at least a portion of the number of tokens to a recipient in response to expiration of a release period, and
transmitting the at least a portion of the number of tokens to the sender in response to execution of a return function of the smart contract.

17. The system of claim 16, wherein execution of the return function is called by a third-party.

18. The system of claim 16, wherein execution of the return function is called by the receiver.

19. The system of claim 16, wherein an address of the smart contract within the cryptocurrency network is provided as a parameter to the pay function.

20. The system of claim 19, wherein the sender receives the address of the smart contract from the recipient.
